(19) United States
(12) Patent Application Publication
(10) Pub. No.: US 2014/0095656 A1
(43) Pub. Date: Apr. 3, 2014

(54) Remote Monitoring of Battery Packs

(71) Applicants: Bjoern Aage Brandal, Tiller (NO); Odd Jostein Svendsli, Trondheim (NO)

(72) Inventors: Bjoern Aage Brandal, Tiller (NO); Odd Jostein Svendsli, Trondheim (NO)

(21) Appl. No.: 13/633,029

(22) Filed: Oct. 1, 2012

(51) Int. Cl. G06F 15/16

(52) U.S. Cl. 709/217

(57) ABSTRACT

The remote monitoring of battery packs installed in devices is disclosed. An example method includes receiving battery pack data by a network server from devices connected to the network server. The data is saved to a database and the database records are analyzed to generate battery pack performance reports and commands and/or parameters to improve performance of the battery packs. The devices can be capable of receiving the commands and/or parameters from the network server to replace or adjust parameters in the battery pack.

### TECHNICAL FIELD

This disclosure relates generally to battery packs and more specifically to monitoring parameters of battery cells in battery packs.

### BACKGROUND

Many devices depend on battery packs for their operation. Battery packs include one or more battery cells. Rechargeable battery packs include battery cells designed to be recharged and used multiple times. Battery management systems are sometimes included in battery packs to monitor the battery cells and to provide data related to different parameters of the battery cells.

### SUMMARY

The remote monitoring of battery packs installed in devices is disclosed. An example method includes receiving battery pack data by a network server from devices connected to the network server. The data is saved to a database and the database records are analyzed to generate battery pack performance and usage pattern reports. The devices can also be capable of receiving commands and/or parameters from the network server to replace or adjust parameters in the battery pack.

In one aspect, an example method includes obtaining battery pack data by a system unit of a device. The method continues with packaging the data and establishing a network connection by the system unit. The method also includes uploading the packaged data to a network.

In another aspect, an example method includes receiving battery pack data from a plurality of devices over one or more networks. The method continues with creating data records from the received data and storing the data records in a searchable database. The method further includes retrieving and analyzing the stored data and creating performance data and/or reports or a set of commands and/or parameters for a battery pack.

In another aspect, a device includes a system unit and one or more battery packs. The system unit includes an interface connected to one or more battery packs to communicate with the battery packs and an interface to communicate with a network. A battery pack can include one or more battery cells and a management system connected to the system unit to communicate with the system unit.

In another example, a system includes a network and a network server connected to the network, and a plurality of devices connected to the network. The devices can upload battery pack data to the network and the server can receive the data from the network. The system further includes a searchable database connected to the network server. The server can store data records to the database and may retrieve data records from the database.

Particular implementations of remote monitoring of battery packs provide one or more of the following advantages. Many devices currently using battery packs have their own battery management system and performance data related to the battery cells of the battery packs are stored inside the devices. The remote collection and analysis of battery pack data from a number of devices in use is helpful for designers and manufacturers of the battery packs or components of the battery packs to reveal defects or other shortcomings of the battery packs or its components. Additionally, the data can be used to generate commands and/or parameters for improving the performance of the battery packs. The commands and/or parameters can be provided to battery packs through a network connection with the device.

### BRIEF DESCRIPTION OF THE DRAWINGS

FIG. 1 is a block diagram of an example system for collecting data from battery packs.

FIG. 2 is a block diagram of an example device of the system shown in FIG. 1.

FIG. 3 is a flow diagram of an example process of obtaining battery pack data by a system unit of a device.

FIG. 4 is a flow diagram of an example process of receiving battery pack data from battery packs and storing the data in a searchable database for further analyzing and reporting.

FIG. 5 is a flow diagram of the example process of FIG. 4 with an additional step of receiving a request for data or a request for a report on a battery model from a client and responding to the client's request.

FIG. 6 is a flow diagram of example process of FIG. 5 including an additional step of a server sending a set of one or more commands or parameters to one or more devices.

### DETAILED DESCRIPTION

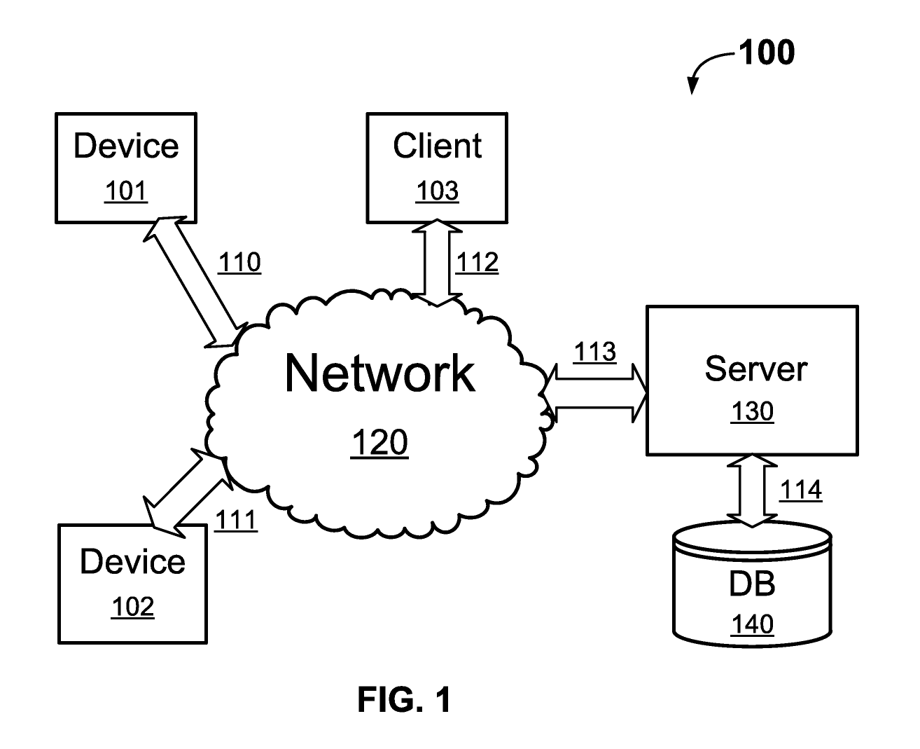

FIG. 1 is a block diagram illustrating an example system 100 that is used to collect data from devices 101 and 102. Devices 101, 102 can be any device that includes a battery pack and is capable of monitoring and reporting battery pack data. For example, device 101 may be a laptop computer and device 102 may be a cell phone. Devices 101, 102 can be configured to couple to network 120 through network connections 110, 111. Devices 101, 102 can upload battery pack data to network 120 through connections 110, 111. Battery pack data can be any data related to a battery pack installed or otherwise coupled to a device.

Network 120 can be coupled to network server 130 through network connection 113. Network connection 113 allows network server 130 to receive data from network 120. Network server 130 can be coupled to searchable database 140. Battery pack data received by network server 120 can be stored in data records of database 140. A network communication protocol can be implemented between devices 101, 102 and network 120 as well as between network server 130 and network 120 through connections 110, 111, and 113. The network communication protocol can be any one or a plurality of standard network protocols. As an example, TCP/IP can be used as the communication protocol in connections 110, 111, 113, and any other connection. Network server 130 can run database software capable of creating and indexing data records from battery pack data. In one example, searchable database 140 can be connected directly to network server 130 as shown in FIG. 1. Network server 130 can store data records in searchable database 140 and retrieve data records from database 140.

The battery pack data may include information related to the manufacturing of the battery pack and its managing system. The data can include but is not limited to: Battery Pack Unique ID, Pack Manufacturer Name and Location, Pack Manufacturing Date, Battery Pack Design Capacity, Battery Cell Manufacturer, Battery Cell Type, Battery Cell Lot Code, Battery Management Unit Manufacturer, Battery Management Device ID and Battery Management Firmware Version.

The battery pack data may also include temperature and electrical data related to each charging of a battery pack, including but not limited to: Normalized Full Charge Capacity, Charge Level at Charger Disconnect, Minimum Temperature, Maximum Temperature, Average Temperature, Maximum Current, and Average Current.

The battery pack data may also include temperature and electrical data related to each discharging of the battery pack including but not limited to: Depth of Discharge, Minimum Temperature, Maximum Temperature, Average Temperature, Maximum Current and Average Current.

The battery pack data may also include electrical data related to each cycle of charge and discharge including but not limited to: Maximum Pack Voltage, Minimum Pack Voltage, Maximum Cell Voltage and Minimum Cell Voltage, as well as time-stamped records of battery protection events.

In some implementations, network server 130 may run software capable of analyzing data records stored in database 140 and generating performance data and/or reports for battery packs, which can be stored in database 140. The performance data may include the raw data of one or more battery cells or packs or may include the processed data of a battery cell or pack model containing statistical parameters including but not limited to average and standard deviation. One example of a report may include the distribution data of the Normalized Full Charge Capacity of one or more battery or cell models per number of times the battery is charged. Another example of a report may include the distribution data of average temperature of one or more battery or cell models during charging. In another implementation, database 140 may be connected through a separate database server (not shown) to network 120 and the software for analyzing data records is on database server. In yet another embodiment, a separate computing device coupled to database 140 runs software capable of retrieving and analyzing battery pack data records stored in database 140, generating performance data, reports, commands and/or parameters from the battery pack data and storing these items in database 140. The reports can be generated periodically and stored in database 140 or may be generated in response to a request by network server 130 or other triggering event. As an example, the reports may be generated on a daily basis.

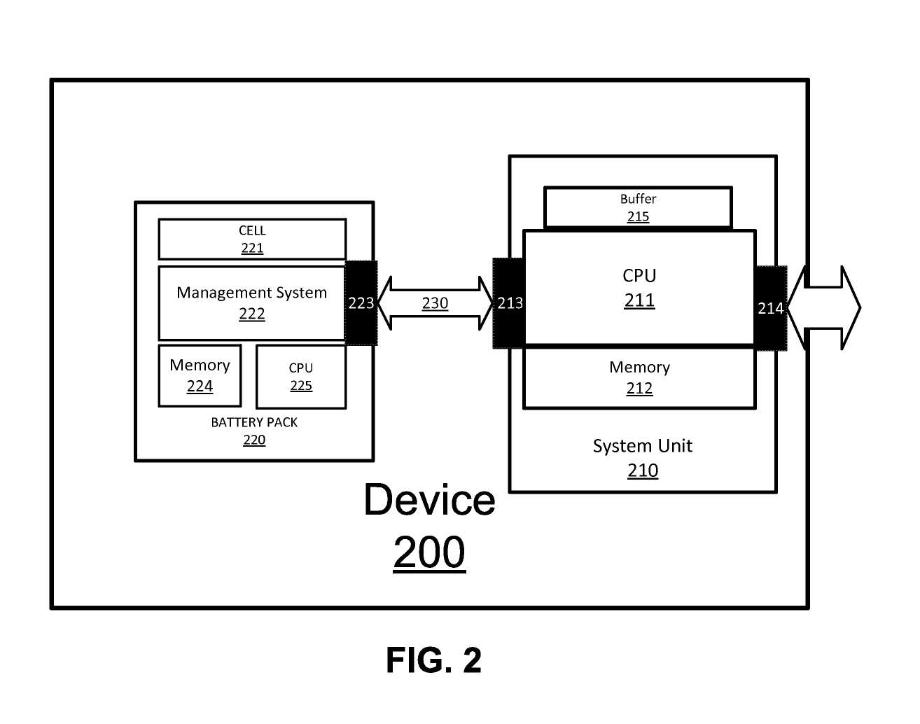

FIG. 2 is a block diagram of device 200 that may be coupled to network 120 as shown in FIG. 1. Device 200 can be, for example, device 101 or device 102 shown in FIG. 1. In some implementations, device 200 can include system unit 210 and battery pack 220. System unit 210 can include at least one CPU 211 and at least one memory unit 212. Battery pack 220 can include one or more battery cells 221 and may include battery management system 222. Battery pack 220 may also include memory unit 224 and CPU 225. System unit 210 can also include interface 230 for CPU 211 to communicate with battery pack 220 and a network interface connected to port 214 to communicate with a network (e.g., network 120). Battery management system 222 may communicate with system unit 210 through interface 230. System unit 210 may also send commands to battery pack 220 to control battery pack 220. As an example, system unit 210 may sent a command to set a characteristic parameter of battery pack 220, including, for example, the maximum capacity of a cell 221 of battery pack 220. For another example, system unit 210 can send a new parameter to replace an old parameter in battery pack 220.

In some implementations, battery management system 222 can periodically sample battery pack 220 and/or cell 221 signals during every cycle of charge and discharge. The sampled signals can include but are not limited to temperature, voltage and the current of each cell 221 and battery pack 220. This data can be acquired by system unit 210 from battery pack 220 through interface 230 . The data may include information related to the production of battery pack 220 and management system 222, and may include one or more of the following battery pack data: Battery Pack Unique ID, Pack Manufacturer Name and Location, Pack Manufacturing Date, Battery Pack Design Capacity, Battery Cell Manufacturer, Battery Cell Type, Battery Cell Lot Code, Battery Management Unit Manufacturer, Battery Management Device ID and Battery Management Firmware Version.

In some implementations, system unit 210 can process acquired data and generate data related to each charging of battery pack 220, including one or more of the following battery pack data: Normalized Full Charge Capacity, Charge Level at Charger Disconnect, Minimum Temperature, Maximum Temperature, Average Temperature, Maximum Current, and Average Current.

System unit 210 can also process the acquired battery pack data and generate data related to each discharging of battery pack 220 including one or more of the following battery pack data: Depth of Discharge, Minimum Temperature, Maximum Temperature, Average Temperature, Maximum Current and Average Current.

System unit 210 can additionally process the acquired data and generate data related to each cycle of charge and discharge, including one or more of the following batter pack data: Maximum Pack Voltage, Minimum Pack Voltage, Maximum Cell Voltage and Minimum Cell Voltage as well as time-stamped records of battery protection events.

In another implementation, the processing of battery pack data can occur inside battery pack 220 using CPU 225, and the processed battery pack data can be obtained by system unit 210.

System unit 210 can store battery pack data in memory (e.g., in a buffer) and/or package data and send packaged data to a server (e.g., network server 130) on a network (e.g., network 120). In one implementation, system unit 210 can upload periodically this data to the network. In another example, system unit 210 may upload this data in response to a triggering event, including but not limited to a battery protection event or a complete battery charge event. In yet another example, system unit 210 can upload battery pack data in response to a request by the network server. Additionally, all of the foregoing examples can occur together.

In some implementations, client 103 can be coupled through connection 112 to network 120, as shown in FIG. 1. Network connection 112 can be bidirectional and client 103 can receive battery pack data from network 120 and send battery pack data or a request to network 120. Although one client is shown in FIG. 1 there may be a plurality of clients connected to network 120. A client can be a user of database 140 that is authorized to receive data or a report from database 140 through network server 130. Clients may include a manufacturer of a battery pack or a component of the battery pack or a manufacturer of a device that uses the battery pack. As an example, client 103 can request a report on a specific component of a battery pack or a report on the whole battery pack from server 130. As another example, client 130 can request raw data related to a specific component of a battery pack or raw data related to the whole battery pack. Authentication software can be implemented on server 130 to check the authenticity of client 103 and the validity of the request. When client 103 is verified and the request is determined to be valid, the battery pack data or reports can be sent to client 103 using network 120 and connections 112, 113.

In system 100 of FIG. 1, network connections 110 and 111 can be bidirectional for uploading battery pack data from devices 101, 102 to network 120 and for receiving instructions from network server 130. An example of a network instruction sent to a device can be a request by network server 130 to upload battery pack data. As another example, network server 130 can send device 101, 102 a set of commands and/or parameters for battery performance improvement to be implemented in the battery pack.

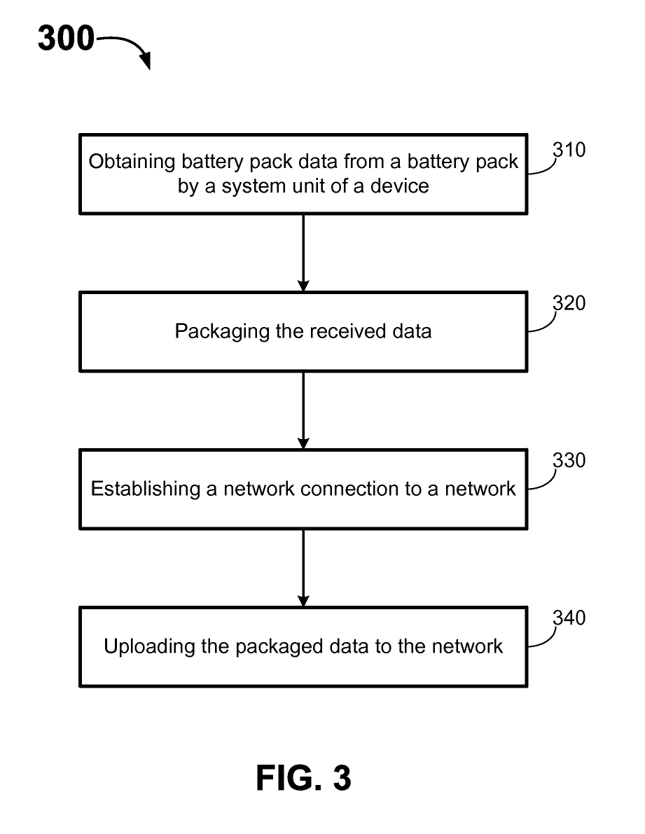

FIG. 3 is a block diagram of process 300 implemented on devices 101, 102 for uploading battery pack data from device 101, 102 to network 120, where devices 101, 102 have the components shown in FIG. 2.

In some implementations, a system unit in a device may obtain the battery pack data from a battery pack in step 310. The system unit packages the data in step 320 and establishes a network connection with a network in step 330. Finally, the system unit uploads the packaged battery pack data in step 340.

Referring to FIG. 2, a request for battery pack data can originate from CPU 211, then be sent through connection 230 to management system 222. In response, management system 222 can send the battery pack data through connection 230 to system unit 210. In one example, system unit 210 can periodically request the data from the battery pack 220. In another example, system unit 210 can receive a request from network server 130 for battery pack data, and in response to the network request, send a request to battery pack 220 for the battery pack data. In yet another example, system unit 210 can request data from battery pack 220 when it receives a triggering event from the battery pack including, for example, one of battery protection and full charge events.

Different methods may be implemented for the system unit to obtain raw or processed battery pack data. In one example, the battery pack may initiate the transfer of data to the system unit. The battery pack may send the data periodically or in response to a triggering event. In another example, system unit 210 may request for the data. In yet another example the battery pack cell(s) may directly be coupled to the system unit and monitored and controlled by system unit 210.

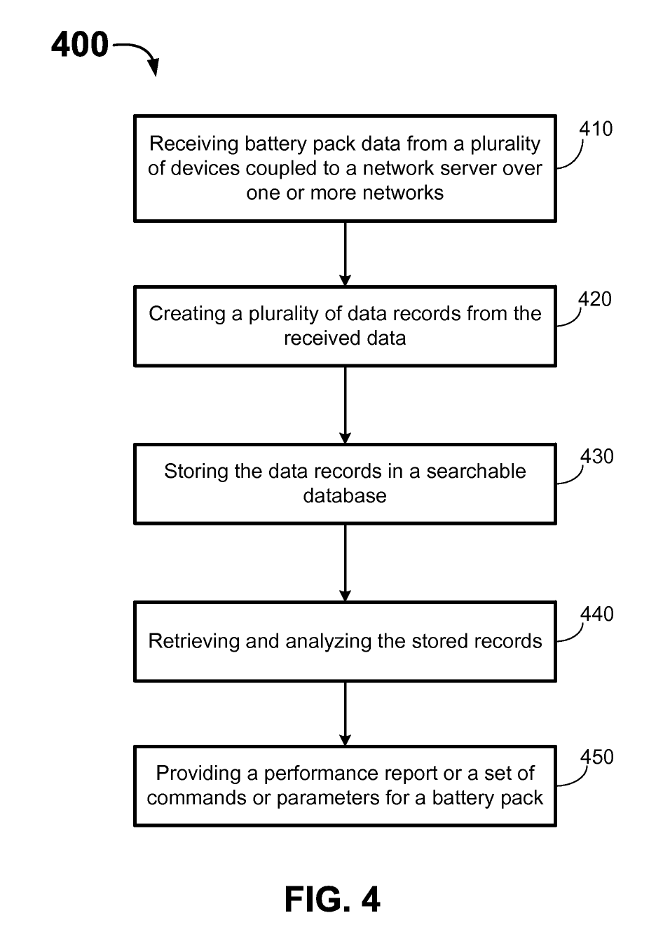

FIG. 4 is a block diagram of process 400 implemented on network server 130 of system 100 having the components shown in FIG. 1. In step 410, the server receives battery pack data from a plurality of devices connected to the network. The server can create data records from the received data in step 420 and stores the records in a searchable database in step 430. Software on the server retrieves the data records and analyzes the records in step 440. In step 450, the server either provides performance reports and/or data for battery packs or battery cells, or provides a set of commands and/or parameters for a battery pack to improve its performance.

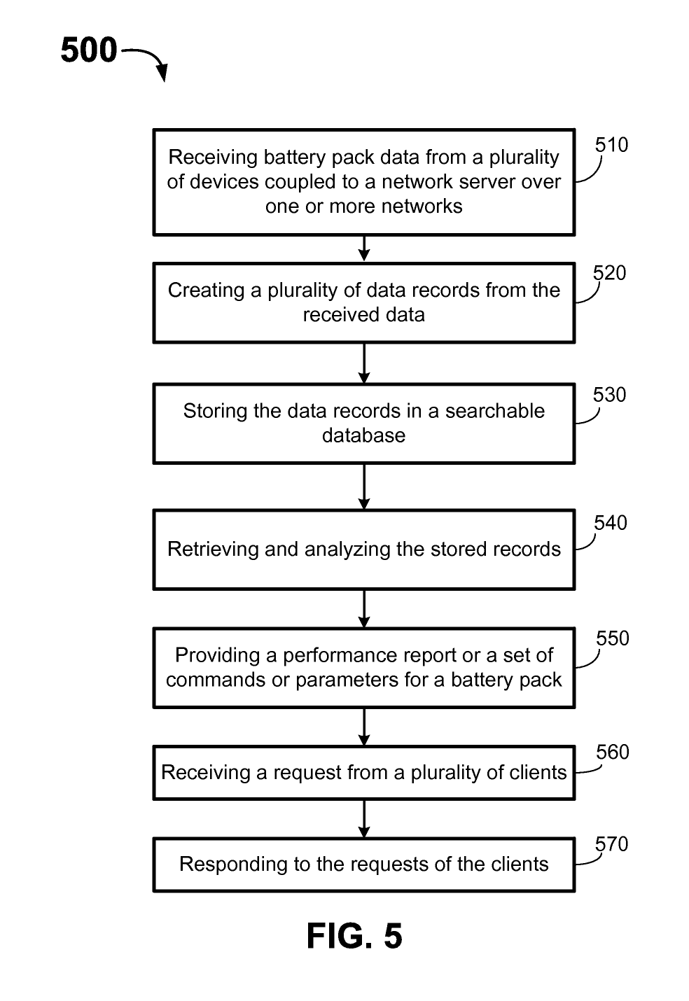

FIG. 5 is a block diagram of process 500 implemented on a server of a network having the components shown in FIG. 1, where a plurality of clients (e.g., client 103) can be connected to network 120 and network server 130 is configured to respond to clients. The steps 510-550 are similar to steps 410-450 in FIG. 4. In step 560, however, the server receives a request from client 103 for a report or raw battery pack data, and in step 570, the network server responds to the requests of the clients by sending the clients the requested report or data.

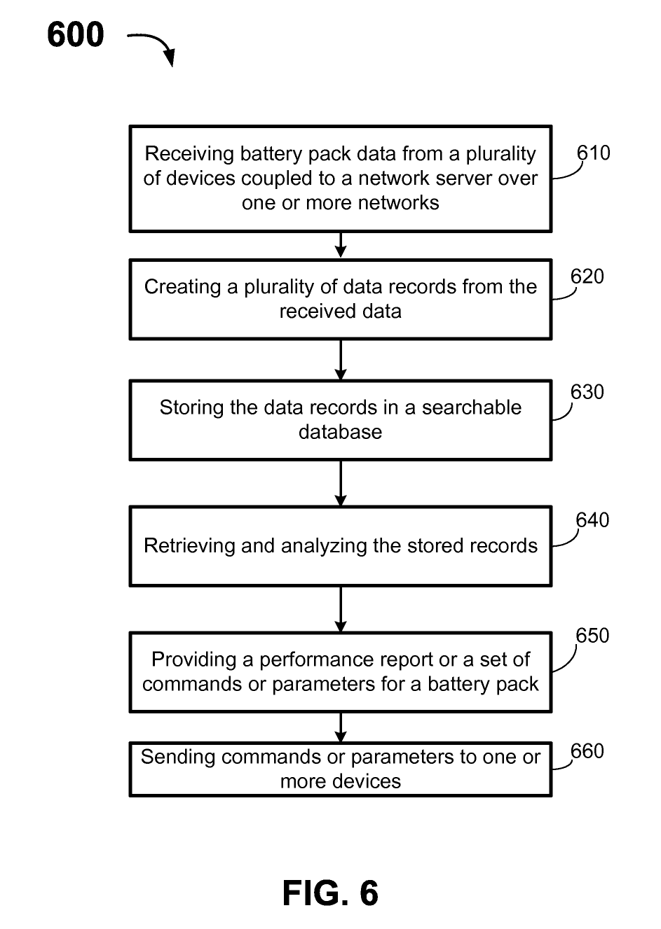

FIG. 6 is a block diagram of process 600 implemented on a network server of a network having the components shown in FIG. 1, where a network server is configured to send instructions or data to one or more devices coupled to the network. The steps 610-650 are similar to steps 410-450 in FIG. 4. In step 660, however, the server sends a set of one or more commands or parameters to one or more devices coupled to the network. The set of commands and/or parameters can adjust or replace parameters of a battery pack for improving the performance of the battery pack installed on the device.

What is claimed is:

1. A method comprising:
obtaining, by a system unit of a device, battery pack data from a battery pack included in or coupled to the system unit;
packaging the data;
establishing a network connection to a network; and
uploading the packaged data to the network,
wherein the method is performed by one or more processors.

2. The method of claim 1, wherein the data includes a battery pack identifying number.

3. The method of claim 1, wherein the data includes a time stamp.

4. The method of claim 1, wherein the data includes manufacturing data associated with the battery pack and battery cells included in the battery pack.

5. The method of claim 1, wherein the data includes manufacturing data associated with a battery pack management system in the battery pack.

6. The method of claim 1, wherein the data includes temperature variation data associated with the battery pack.

7. The method of claim 1, wherein the data includes electrical measurement data associated with the battery pack.

8. The method of claim 1, wherein the data includes electrical measurement data of one or more battery cells included in the battery pack.

9. The method of claim 1, wherein the data includes battery protection event data.

10. The method of claim 1, wherein the system unit uploads periodically the data to the network.

11. The method of claim 1, whereas the system unit uploads the monitoring data in response to one of:
a request from the network; and
a triggering event from the battery pack.

12. The method of claim 1, wherein the system unit includes one or more rechargeable battery packs, and wherein the device uploads data of one or more rechargeable battery packs to the network.

13. The method of claim 1, wherein the system unit receives from the network, a set of one or more commands or parameters for a battery pack, and wherein the system unit sends the one or more commands or parameters to a management system of the battery pack.

14. A method comprising:
receiving, by a network server, battery pack data from a plurality of devices coupled to the network server over one or more networks;
creating a plurality of data records from the received data;
storing the data records in a searchable database;
retrieving and analyzing the stored records; and
providing one of a performance report or a set of one or more commands or parameters for a battery pack,
wherein the method is performed by one or more processors.

15. The method of claim 14, wherein a plurality of clients are connected to the network server, and wherein the network server receives a request from one or more clients, and wherein the network server responds to the requests of the clients.

16. The method of claim 14, wherein the network server sends the set of one or more commands or parameters to one or more devices.

17. The method of claim 16, wherein the set of one or more commands or parameters is applied to a battery pack.

18. The method of claim 14, wherein a report includes one of:
charge data of a battery cell; and
charge data of a battery model.

19. The method of claim 14, wherein a report includes one of:
discharge data of a battery cell; and
discharge data of a battery model.

20. The method of claim 14, wherein a report includes one of:
temperature variation data of a battery cell; and
temperature variation data of a battery model.

21. The method of claim 14, wherein a report includes a full charge capacity per number of times charged of one of:
a battery cell; and
a battery pack; and
a battery cell model; and
a battery pack model.

22. A device comprising:
a battery pack including a management system and one or more memory cells, the management system configured to monitor the one or more battery cells and to generate data associated with the one or more battery cells;
a first interface coupled to the battery pack and configured to receive the data from the battery pack;
a second interface configured for coupling to a bidirectional network; and
a system unit coupled to the first and second interface and configured to send data to the bidirectional network.

23. A system comprising:
a network server connected to a network and configured to receive data from the network;
a plurality of devices connected to the network, at least some of the devices configured to upload data to the network server; and
a database connected to the network server and configured for storing or retrieving data records to or from the database.

24. A system of claim 23, wherein one or more clients are connected to the network, and wherein the clients may send one or more requests through the network to the server, and wherein the server may respond through the network to the clients.

25. A system of claim 24, wherein the server may command one or more devices to download one or more commands or parameters from the network.
